(19) United States
(12) Patent Application Publication
(10) Pub. No.: US 2018/0337615 A1
(43) Pub. Date: Nov. 22, 2018

(54) TIRE ENERGY RECOVERY SYSTEM

(71) Applicants: Mohammed Abdulraouf S. ALMAGHRABI, Boston, MA (US); Zekra Amar O. ALHAZMI, Boston, MA (US)

(72) Inventors: Mohammed Abdulraouf S. ALMAGHRABI, Boston, MA (US); Zekra Amar O. ALHAZMI, Boston, MA (US)

(21) Appl. No.: 15/598,069

(22) Filed: May 17, 2017

(51) Int. Cl. H02N 2/18; B60G 13/08; B60K 1/04; B60L 11/18

(52) U.S. Cl. CPC H02N 2/181; B60G 13/08; B60K 1/04; B60Y 2400/204; B60K 2001/0438; B60Y 2300/91; B60L 11/1809

(57) ABSTRACT

An energy recovery system for a vehicle including a battery assembly with a battery providing input electricity, and an amplifier receiving the input electricity and providing amplified input electricity, and a wheel assembly in contact with road deformations to provide output electricity to the battery assembly. The tire assembly having a tire assembly with a tire, and a plurality of electroactive modules affixed to the tire to provide the output electricity when the vehicle goes over the road deformations, and a rim assembly with a rim affixed to the tire, and a dual slip ring connector affixed to the rim transmitting the amplified input electricity from the amplifier to the plurality of electroactive modules and the output electricity from the plurality of electroactive modules to the battery, while the vehicle is in motion.

### GRANT OF NON-EXCLUSIVE RIGHT

This application was prepared with financial support from the Saudi Arabian Cultural Mission, and in consideration therefore the present inventor(s) has granted The Kingdom of Saudi Arabia a non-exclusive right to practice the present invention.

### BACKGROUND

In today's automotive industry, producing vehicles that maximize fuel economy is essential.

Such a demand in fuel economy can be addressed with energy recovery systems that harvest energy that would be otherwise wasted by being transfer and/or evacuated to the external environment.

To this end, conventional recovery systems can be placed throughout a drive train of the vehicle to harvest different type of energies that are wasted when the vehicle is operated. For example, the conventional recovery systems may be positioned on the exhaust system of the drive train and rely on turbo systems to harvest thermal energy present in exhaust gases and evacuated to the external environment through the exhaust system. In another example, the conventional systems may be positioned on a braking system of the vehicle and rely on freewheel systems to harvest kinetic energy wasted by the braking system when the vehicle slows down.

Although such conventional recovery systems are widely used throughout the drive train of the vehicle to harvest wasted energy, they present important drawbacks in capturing and recovering energy wasted due to interactions between the vehicle and the road, and notably interactions between the vehicle and road imperfections, e.g. potholes, speed bumps, gravel, or the like.

Thus, an energy recovery system solving the aforementioned harvesting energy from the road imperfections is desired.

### SUMMARY

Accordingly, the object of the present disclosure is to provide an energy recovering system that captures and recovers energy wasted by interactions between the vehicle and the road imperfections.

The disclosed energy recovering system recovers energy from the road imperfections by harvesting energy from relative motions between the vehicle and the road and from tire deformations generated by the road imperfections on the tires when the vehicle goes over the road imperfections.

In one non-limiting illustrative example, an energy recovery system for a vehicle. The energy recovery system includes a suspension assembly having a linear generator that provides input electricity when the vehicle goes over road deformations, a battery assembly that is in electrical contact with the suspension assembly, the battery assembly having a battery, and an amplifier that receives the input electricity from the linear generator and provides amplified input electricity, and a wheel assembly that is rotatably affixed to the suspension assembly, the wheel assembly having a tire assembly that contacts the road deformations, the tire assembly having, a tire, and a plurality of electroactive modules affixed to the tire that provides output electricity when the vehicle goes over the road deformations, and a rim assembly that supports the tire assembly, the rim assembly having a rim that is affixed to the tire, and a dual slip ring connector that is affixed to the rim and that transmits the amplified input electricity from the amplifier to the plurality of electroactive modules and the output electricity from the plurality of electroactive modules to the battery, while the vehicle is in motion.

In another non-limiting illustrative example, an energy recovery system for a vehicle. The energy recovery system includes a battery assembly, the battery assembly having a battery that provides input electricity, and an amplifier that receives the input electricity and provides amplified input electricity, and a wheel assembly that is electrically connected to the battery assembly, the wheel assembly having a tire assembly that contacts road deformations, the tire assembly having a tire, and a plurality of electroactive modules that is affixed to the tire that provides output electricity when the vehicle goes over the road deformations, and a rim assembly that supports the tire assembly, the rim assembly having a rim that is affixed to the tire, and a dual slip ring connector that is affixed to the rim that transmits the amplified input electricity from the amplifier to the plurality of electroactive modules and the output electricity from the plurality of electroactive modules to the battery, while the vehicle is in motion.

In another non-limiting illustrative example, an energy recovery system for a vehicle. The energy recovery system includes a battery assembly having a battery that provides input electricity, and an amplifier that receives the input electricity and provides amplified input electricity, and a wheel assembly that is electrically connected to the battery assembly, the wheel assembly having a tire assembly that contacts road deformations, the tire assembly having a tire, and a plurality of electroactive modules that is affixed to the tire that provides output electricity when the vehicle goes over the road deformations, and a rim assembly that supports the tire assembly, wherein the rim assembly transmits the amplified input electricity from the amplifier to the plurality of electroactive modules and the output electricity from the plurality of electroactive modules to the battery, while the vehicle is in motion.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a perspective view of an energy recovery system of a vehicle, according to certain aspects of the disclosure;

FIG. 2A is a perspective view of a suspension assembly of the energy recovery system in a expanded state, according to certain aspects of the disclosure;

FIG. 2B is a perspective view of the suspension assembly of the energy recovery system in an contracted state, according to certain aspects of the disclosure;

FIG. 3 is sectional view of a linear generator of the suspension assembly, according to certain aspects of the disclosure;

FIG. 4 is a sectional view of a wheel assembly of the energy recovery system, according to certain aspects of the disclosure;

FIG. 5 is an exploded view of a dual slip ring connector of the wheel assembly, according to certain aspects of the disclosure;

FIG. 6 is an exploded view of an electroactive module of the wheel assembly, according to certain aspect of the disclosure;

FIG. 7 is a schematic view of a battery assembly of the energy recovery system, according to certain aspects of the disclosure;

FIG. 8 is a flow chart of a method for harvesting energy through the energy recovery system, according to certain aspects of the disclosure; and

FIG. 9 is a schematic view of a hardware diagram of an electrical control unit of the battery assembly, according to certain aspects of the disclosure.

### DETAILED DESCRIPTION

All publications, patent applications, patents, and other references mentioned herein are incorporated by reference in their entirety. Further, the materials, methods, and examples discussed herein are illustrative only and are not intended to be limiting.

In the drawings, like reference numerals designate identical or corresponding parts throughout the several views. Further, as used herein, the words “a”, “an”, and the like include a meaning of “one or more”, unless stated otherwise. The drawings are generally drawn not to scale unless specified otherwise or illustrating schematic structures or flowcharts.

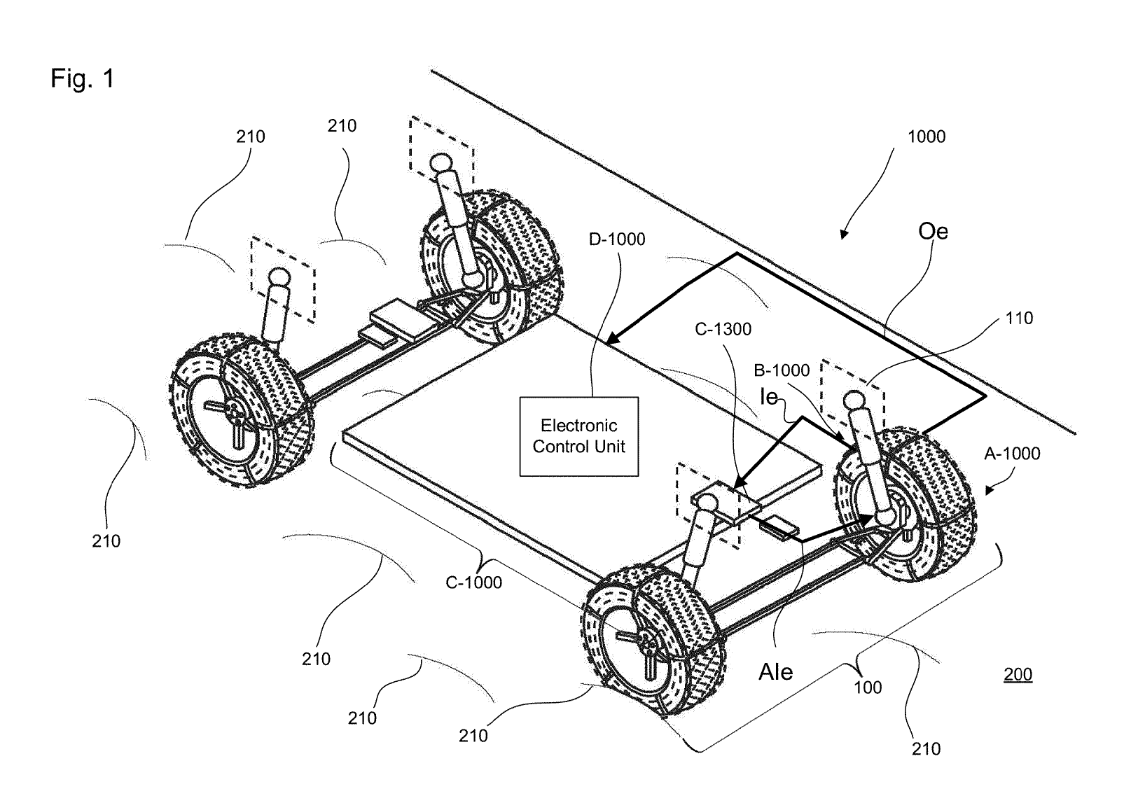

FIG. 1 is a perspective view of an energy recovery system 1000 of a vehicle 100, according to certain aspects of the disclosure.

The energy recovery system 1000 is configured to harvest mechanical energy generated on the vehicle 100 by road imperfections 210 present on a road 200, e.g. potholes, speed bumps, gravel, or the like, to enhance energy efficiency and gas mileage of the vehicle 100.

The energy recovery system 1000 can convert mechanical energy generated by passage of the vehicle 100 over the road imperfections 210 into electrical energy, wherein the mechanical energy can be in the form of tire deformations, e.g. tread shape and/or sidewall profile distortions, and/or suspension oscillations, e.g. relative motions between the road 200 and the vehicle 100.

The energy recovery system 1000 can include a wheel assembly A-1000 in contact with the road 200, a suspension assembly B-1000 that supports the wheel assembly A-1000, and a battery assembly C-1000 in electrical contact with the wheel assembly A-1000 and the suspension assembly B-1000.

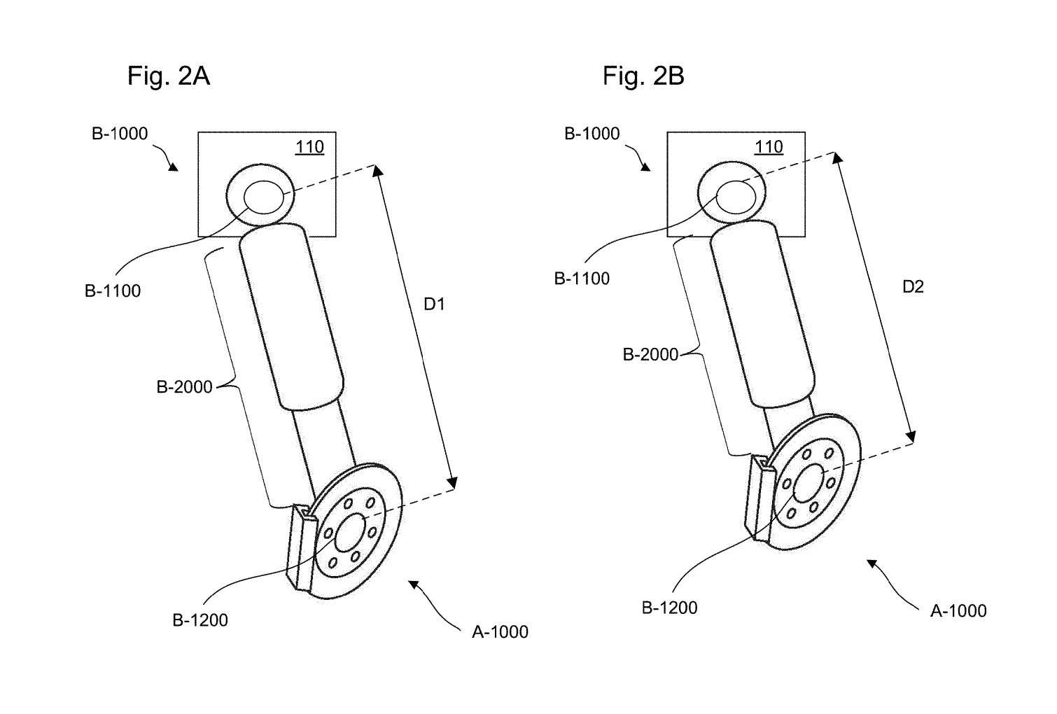

Under the passage of the vehicle 100 on the road imperfections 210, the suspension assembly B-1000 can generate input electricity Ie from the suspension oscillations, the wheel assembly A-1000 can receive amplified input electricity AIe amplified from the input electricity Ie by the battery assembly C-1000 and generate output electricity Oe, and the battery assembly C-1000 can receive and store the output electricity Oe to be later used in other elements of the vehicle 100, e.g. electric driving train, air conditioning system, and/or lighting system. FIGS. 2A-2B are perspective views of the suspension assembly B-1000 of the energy recovery system 1000 in a contracted state and in an expanded state, according to certain aspects of the disclosure.

The suspension assembly B-1000 can include a first pivot B-1100 affixed to a rigid structure 110 of the vehicle 100, see FIG. 1, e.g. chassis, a second pivot B-1200 affixed to the wheel assembly A-1000, a linear generator B-2000 slidly affixing the first pivot B-1100 with the second pivot B-1200 to follow the suspension oscillations.

When the vehicle 100 goes over the road imperfections 210, see FIG. 1, the suspension assembly B-1000 can oscillate between an expanded state, as illustrated in FIG. 2A, and a contracted state, as illustrated in FIG. 2B, to provide the suspension oscillations. In the extended state the first pivot B-1100 and the second pivot B-1200 are distanced by a predetermined extended distance D1, while in the contracted state the first pivot B-1100 and the second pivot B-1200 are distanced by a predetermined contracted distance D2 smaller than the predetermined extended distance D1. The predetermined extended distance D1 and the predetermined contracted distance D2 are determined to provide amplitudes of the suspensions oscillations sufficiently large to absorb the road imperfections 210, see FIG. 1, and provide a smooth ride.

The suspension oscillations of the suspension assembly B-1000 between the contracted state and the extended extend compress and extend the linear generator B-2000 that captures and converts the suspension oscillations into the input electricity Ie.

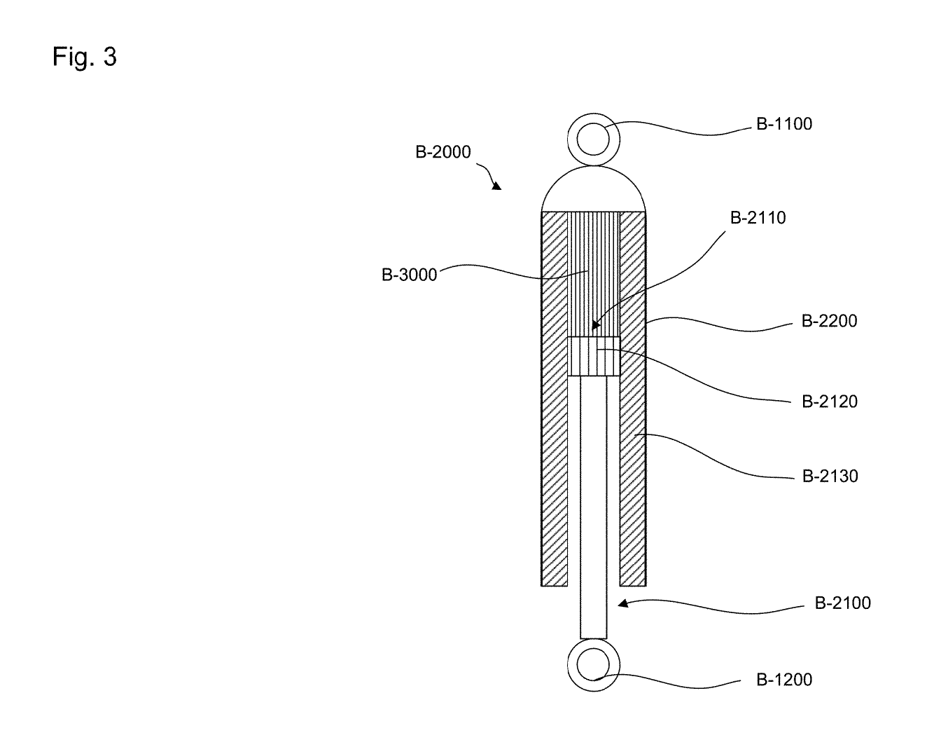

FIG. 3 is sectional view of the linear generator B-2000 of the suspension assembly B-1000, according to certain aspects of the disclosure.

The linear generator B-2000 can be configured to provide the input electricity Ie when the suspension assembly B-1000 is articulated between the extended state, see FIG. 2A, and the contracted state, see FIG. 2B, and vice-versa, to capture the suspension oscillations generated by the passage of the vehicle 100 over the road imperfections 210.

The linear generator B-2000 can include a piston B-2100 affixed to the second pivot B-1200 and a cylinder B-2200 affixed by one extremity to the first pivot B-1100 and opened on a second extremity to receive the piston B-2100. The piston B-2100 can include a piston head B-2110 slidingly inserted in the cylinder B-2200, permanent magnets B-2120 positioned radially around the piston head B-2110 to face coils B-2130 positioned radially along an internal surface of the cylinder B-2200.

When the linear generator B-2000 is articulated between the extended state and the contracted state, and vice-versa, the piston head B-2110 with the permanent magnets B-2120 slides along a length of the cylinder B-2200 and the coils B-2130. Interactions between radially directed magnetic fields produced by the permanent magnets B-2120 on the coils B-2130 can generate the input electricity Ie.

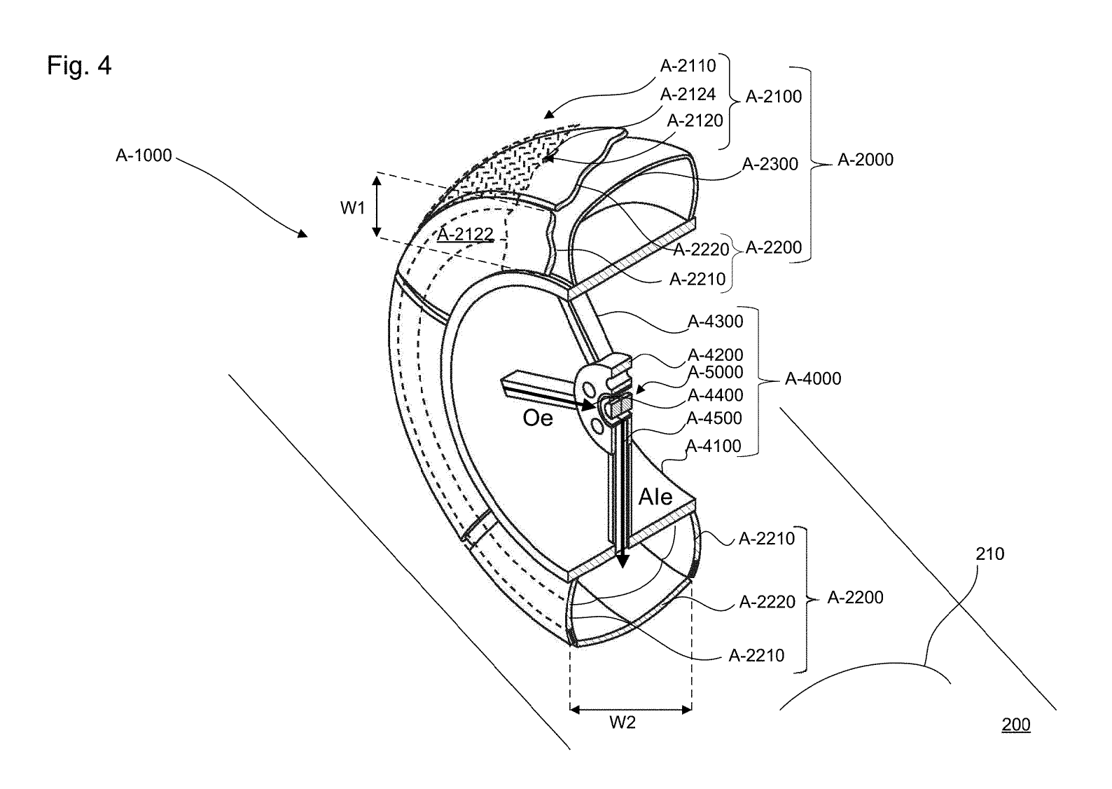

In an alternative illustrative example, the suspension assembly B-1000 can include damping elements positioned internally and/or externally to the linear generator B-2000 configured to partially or totally absorb the road imperfections 210 and provide comfort for passengers of the vehicle 100. For example, the damping elements can be a coil spring positioned concentrically and peripherally to the linear generator B-200 to en the suspension oscillations. In another example, hydraulic fluids B-3000, e.g. air and/or oil, can be placed between the piston head B-2110 and the cylinder B-2200, as illustrated in FIG. 4, to be compressed and extended by the piston head B-2110.

FIG. 4 is a sectional view of the wheel assembly A-1000 of the energy recovery system 1000, according to certain aspects of the disclosure.

Under the passage of the vehicle 100 on the road imperfections 210, as illustrated in FIG. 1, the wheel assembly A-1000 can undergo tire deformations and under electrical excitement provided by the amplified input electricity AIe, the wheel assembly A-1000 can generate the output electricity Oe.

The wheel assembly A-1000 can include a tire assembly A-2000 in contact with the road imperfections 210, see FIG. 1, and a rim assembly A-4000 that supports the tire assembly A-2000 and that is rotatably affixed to the suspension assembly B-1000, see FIGS. 2A-2B.

The tire assembly A-2000 can receive amplified input electricity AIe providing by the application of the input electricity Ie by the battery assembly C-1000 and generates output electricity Oe from the tire deformations. The rim assembly A-4000 can transfer the amplified input electricity AIe from the battery assembly C-1000 to the tire assembly A-2000 and the output electricity Oe from the tire assembly A-2000 to the battery assembly C-1000 while the vehicle 100 in motion, see FIG. 1.

The tire assembly A-2000 can include a tire A-2100 with a tire external surface A-2110 in contact with the road 200, a plurality of electroactive modules A-2200 placed on an internal tire surface A-2120 of the tire A-2100, and a fabric A-2300 that can cover the plurality of electroactive modules A-2200.

The plurality of electroactive modules A-2200 can receive and be electrically excited by the amplified input electricity AIe from the battery assembly C-1000, see FIG. 1, and provide the output electricity Oe as the plurality of electroactive modules A-2200 follows and is deformed by the tire deformations when the wheel assembly A-1000 goes over the road imperfections 210.

The fabric A-2300 can maintain the plurality of electroactive modules A-2200 against the internal tire surface A-2120 and provide to the plurality of electroactive modules A-2200 structural support to avoid excessive deformations and protection against external elements, e.g. water, dust, impurities, that may infiltrate between the internal tire surface A-2120 and the rim assembly A-4000.

The plurality of electroactive modules A-2200 can include a first plurality of electroactive modules A-2210 that covers an internal sidewall surface A-2122 of the internal tire surface A-2120 and a second plurality of electroactive modules A-2220 that covers an internal tread surface A-2124 of the internal tire surface A-2120.

The first plurality of electroactive modules A-2210 and the second plurality of electroactive modules A-2220 can have similar functionality and elements but with different geometrical characteristics, e.g. dimensions and/or shapes, to better match and follow the tire deformations. For example, the first plurality of electroactive modules A-2210 can have a first width W1 corresponding to a height of the tire A-2100 while the second plurality of electroactive modules A-2220 can have a second width W2 corresponding to a width of the tire A-2100.

In addition each electroactive module of the plurality of electroactive modules A-2200 can be electrically connected between each other in parallel to provide the output electricity Oe corresponding to the summation of each individual voltage from each electroactive module of the plurality of electroactive modules A-2200.

The fabric A-2300 can maintain the plurality of electroactive modules A-2200 against the internal tire surface A-2120. The fabric A-2300 can be made of deformable materials with relative good resistance to abrasion such as elastomers and/or synthetic fibers and be glued and/or stitched onto the internal tire surface A-2120 and on the plurality electroactive modules A-2200.

The rim assembly A-4000 can support the tire assembly A-2000 and transmit the amplified input electricity AIe from the battery assembly C-1000, see FIG. 1, to the plurality of electroactive modules A-2200, and transmit the output electricity Oe from the plurality of electroactive modules A-2200 to the battery assembly C-1000, see FIG. 1.

The rim assembly A-4000 can include a rim A-4100 anchored to the tire A-2100, a hub A-4200 rotably affixed to the suspension assembly B-1000, see FIGS. 2A-2B, to allow rotation of the rim assembly A-4000 and motion of the vehicle 100, spokes A-4300 that connect the hub A-4200 to the rim A-4100, input wires A-4500 that go from the battery assembly C-1000 to the plurality of electroactive modules A-2200 through the hub A-4200, along the spokes A-4300, and through the rim A-4100, and output wires A-4400 that go from the plurality of electroactive modules A-2200 to the battery assembly C-1000, see FIG. 1, through the rim A-4100, along the spokes A-4300, and through the hub A-4200.

The input wires A-4500 can carry the amplified input electricity AIe from the battery assembly C-1000, see FIG. 1, to the plurality of electroactive modules A-2200, while the output wires A-4400 can carry the output electricity Oe from the electroactive modules A-2200 to the battery assembly C-1000, see FIG. 1.

The hub A-4200 can include a dual slip ring connector A-5000 that provide continuous electrical connections for both the input wires A-4500 and the output wires A-4400 through the hub A-4200 while the rim assembly A-4000 is rotating.

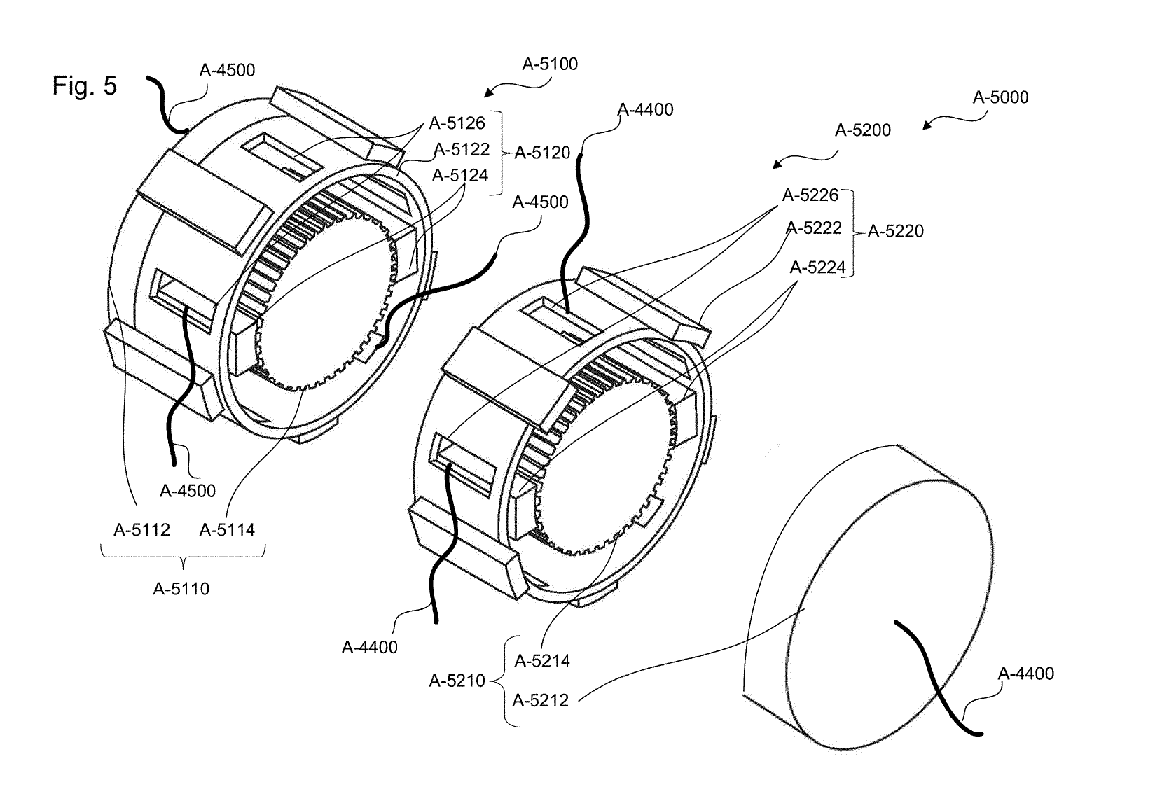

FIG. 5 is an exploded view of the dual slip ring connector A-5000 of the wheel assembly A-1000, according to certain aspects of the disclosure.

The dual slip ring connector A-5000 can include a first ring connector A-5100 to electrically connect the input wires A-4500 and a second ring connector A-5200 to electrically connect the output wires A-4400 while the wheel assembly A-1000 is rotating. The first ring connector A-5100 can provide electrical connections for the amplified input electricity AIe to travel from the battery assembly C-1000 to the hub A-4200 and from the hub A-42000 to the plurality of electroactive modules A-2200, via the spokes A-4300 and the rim A-4100, as illustrated FIG. 4, while the second ring connector A-5200 can provide electrical connections for the output electricity Oe to travel from the plurality of electroactive modules A-2200 to the hub A-4200, via the rim A-4100 and the spokes A-4300, and from the hub A-4200 to the battery assembly C-1000, as illustrated in FIG. 4.

The first ring connector A-5100 and the second ring connector A-5200 can be substantially similar and rely on similar elements and be affixed and/or mounted opposite of each other.

For example, the first ring connector A-5100 can include a first rotating part A-5110 that rotates with the rim assembly A-4000, a first stationary part A-5120 that stays stationary and in contact with the first rotating part A-5110 by slipping and/or brushing on the first rotating part A-5110.

The first stationary part A-5120 can include a first stationary ring A-5122 inserted around the first rotating part A-5110, a first pair of brushes A-5124 supported by the first stationary ring A-5122 that contacts the first stationary part A-5120, and a first plurality of openings A-5126 positioned radially around the first stationary ring A-5122 that provides electrical connections between the first stationary ring A-5122 and the input wires A-4500.

The first rotating part A-5110 can include a first rotating seat A-5112 affixed to the rim A-4100, a first rotating shaft A-5114 that protrudes from the first rotating seat A-5112 and between the first pair of brushes A-5124. The first pair of brushes A-5124 can provide electrical connections between the first stationary part A-5120 and the first rotating part A-5110 by slipping and/or brushing on the first rotating shaft A-5114 that rotates with the rim A-4100 when the vehicle 100 is in motion.

Similarly as the first ring connector A-5100, the second ring connector A-5200 can include a second rotating part A-5210 that rotates with the rim assembly A-4000, a second stationary part A-5220 that stays stationary and in contact with the second rotating part A-5210 by slipping and/or brushing on the second rotating part A-5210.

The second stationary part A-5220 can include a second stationary ring A-5222 inserted around the second rotating part A-5210, a second pair of brushes A-5224 supported by the second stationary ring A-5222 that contacts the second stationary part A-5220, and a second plurality of openings A-5226 positioned radially around the second stationary ring A-5222 to provide electrical connections between the second stationary ring A-5222 and the output wires A-4400.

The second rotating part A-5210 can include a second rotating seat A-5212 affixed to the rim A-4100, a second rotating shaft A-5214 that protrudes from the second rotating seat A-5212 and between the second pair of brushes A-5224. The second pair of brushes A-5224 can provide electrical connections between the second stationary part A-5220 and the second rotating part A-5210 by slipping and/or brushing on the second rotating shaft A-5214 that rotates with the rim A-4100 when the vehicle 100 is in motion.

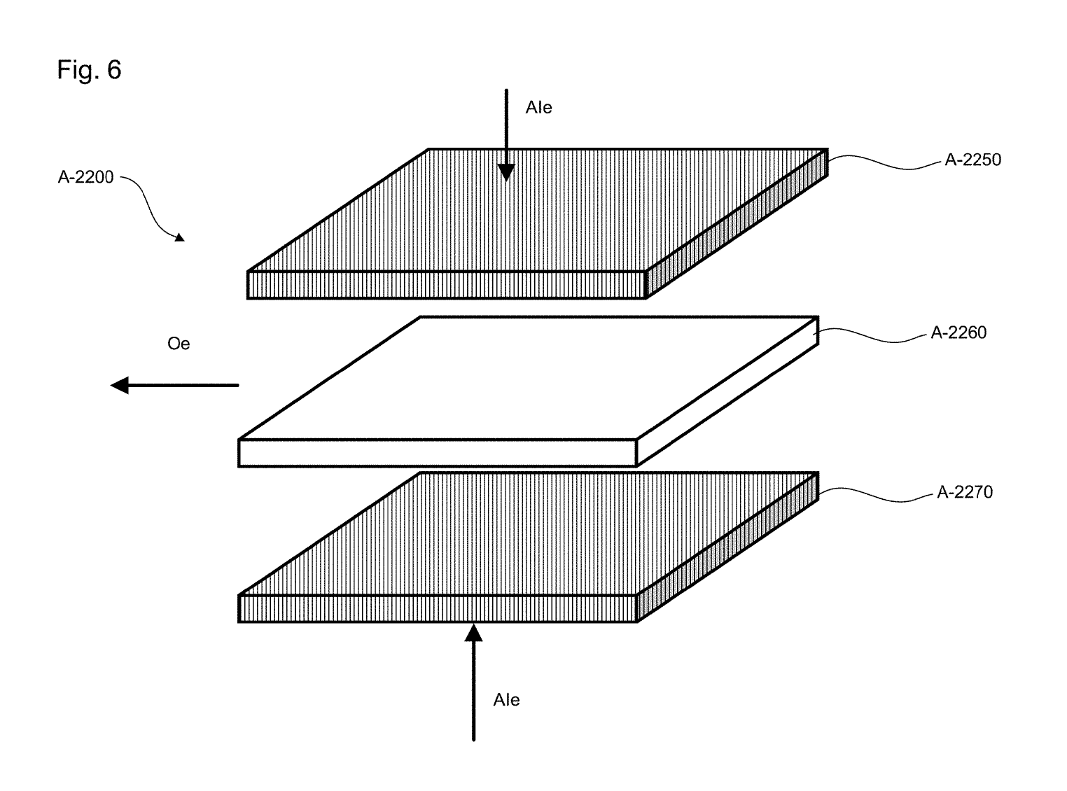

FIG. 6 is a exploded view of the plurality of electroactive modules A-2200 of the wheel assembly A-1000, according to certain aspects of the disclosure.

The plurality of electroactive modules A-2200 can be configured to be excited by the amplified input electricity AIe, absorb mechanical energy from the tire deformations, and convert the absorbed mechanical energy into electrical energy to provide the output electricity Oe.

Each electroactive module of the plurality of electroactive modules A-2200 can be a multi-layer electroactive polymer having a top layer A-2250, a bottom layer A-2270 and a middle layer A-2260 sandwiched between the top layer A-2250 and the bottom layer A-2270.

The top layer A-2250 and the bottom layer A-2270 can conduct the amplified input electricity AIe and act as electrodes to generate an electrical field through the middle layer A-2260. The middle layer A-2260 can act as an electrical isolator between the top layer A-2250 and the bottom layer A-2270 and deflect, e.g. contract or expand, under the tire deformations. For example, the top layer A-2250 and the bottom layer A-2270 can contain electrical conductive materials, such as metallic materials.

The middle layer A-2260 can contain elastic materials capable of being non-conductive when unexcited, e.g. when the amplified input electricity AIe is not received by the top layer A-2250 and the bottom layer A-2270, and being conductive when excited, e.g. when the amplified input electricity AIe is received by the top layer A-2250 and/or the bottom layer A-2270. For example, such materials can be silicon based materials.

Under tire deformations, the middle layer A-2260 can contract or expand, forcing the top layer A-2250 and the bottom layer A-2270 to get closer or further away from each other, thus varying spacing between the top layer A-2250 and the bottom layer A-2270. The spacing variation between the top layer A-2250 and the bottom layer A-2270 can modify the electrical field through the middle layer A-2260 and generate a surplus of electrical power under the form of the output electricity Oe.

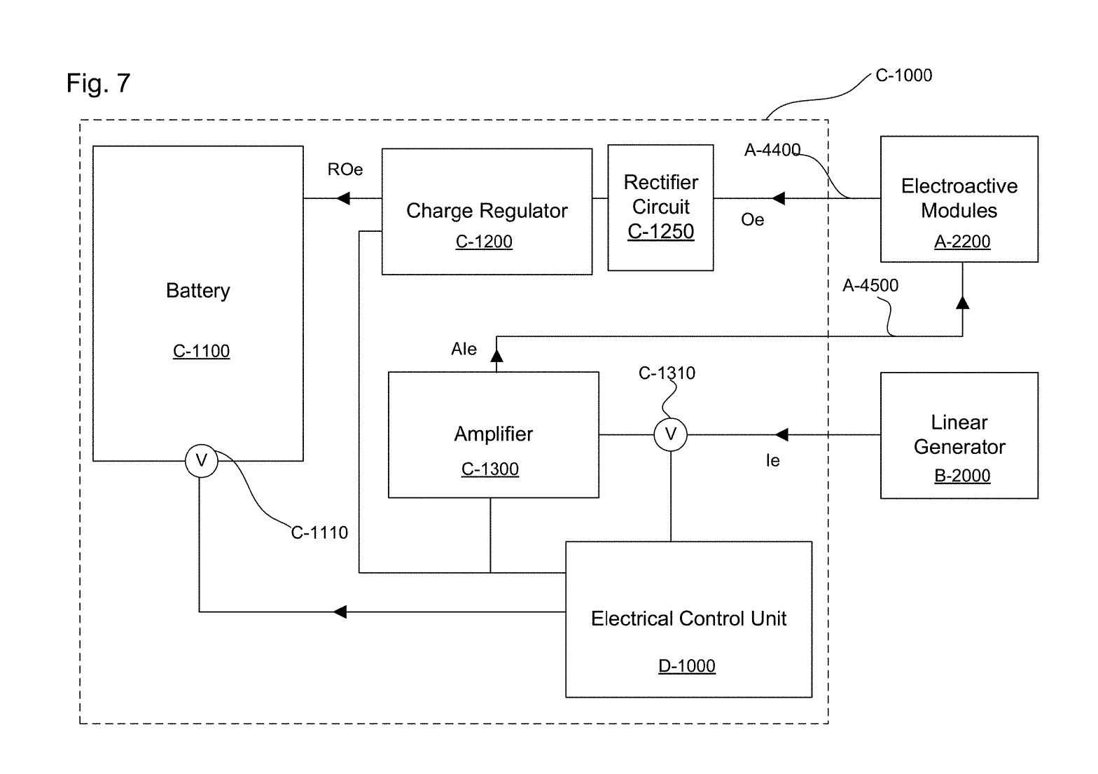

FIG. 7 is a schematic view of the battery assembly C-1000 of the energy recovery system 1000, according to certain aspects of the disclosure.

The battery assembly C-1000 can include a battery C-1100 with a battery voltmeter C-1110, a charge regulator C-1200 electrically connecting the plurality of electroactive modules A-2200 to the battery C-1100, an amplifier C-1300 electrically connecting the linear generator B-2000 to the plurality of electroactive modules A-2200, an input voltmeter C-1310 positioned between the amplifier C-1300 and the linear generator B-2000, and an electronic control unit D-1000 that can actuate the charge regulator C-1200 and the amplifier C-1300 and read the battery voltmeter C-1110 and the input voltmeter C-1310.

The amplifier C-1300 can receive the input electricity Ie from the linear generator B-2000 and amplify the input electricity Ie to provide the amplified input electricity AIe to the plurality of electroactive modules A-2200. The amplifier C-1300 can increase the input electricity Ie to provide the amplified input electricity AIe with sufficient voltage to excite the plurality of electroactive modules A-2200.

The charge regulator C-1200 can receive the output electricity Oe from the plurality of electroactive modules A-2200 and regulate the output electricity Oe to provide a regulated output electricity Roe to the battery C-1100. The charge regulator C-1200 can prevent transferring over voltages to the battery C-1100 to enhance battery performance and lifespan by providing the regulated output electricity ROe as an average of the output electricity Oe over a predetermined period of time. The charge regulator C-1200 can be a stand-alone device, as illustrated in FIG. 7, or circuitry integrated to the battery C-1100. To provide the regulated output electricity ROe, the charge regulator C-1200 can rely on Pulse Width Modulation (PWM) and/or Maximum Power Point-Tracker (MPPT) technologies.

In addition, the charge regulator C-1200 can be coupled with a rectifier circuit C-1250 to rectify the output electricity Oe that can be an alternative current due to the rotation of the tire assembly A-1000 and provide a direct current to the charge regulator C-1200.

The battery C-1100 can store the regulated output electricity ROe to be later used in other elements of the vehicle 100, e.g. electric driving train, air conditioning system, and/or lighting system. The battery C-1100 can be a single or a plurality of alkaline batteries, lead acid batteries, lithium-ion batteries, or the like.

The electrical control unit D-1000 can monitor and control the energy recovery system 1000 by receiving reading signals from the charge voltmeter indicative of a charge level of the battery C-1100 and reading signals from the input voltmeter C-1310 indicative of a voltage value of the input electricity Ie, as well as by providing to the charge regulator C-1200 command signals indicative of a voltage decrease of the output electricity Oe and to the amplifier C-1300 command signals indicative of a voltage increase of the input electricity Ie.

The electrical control unit D-1000 and functionalities associated with the electrical control unit D-1000 will be described in details in following paragraphs and figures.

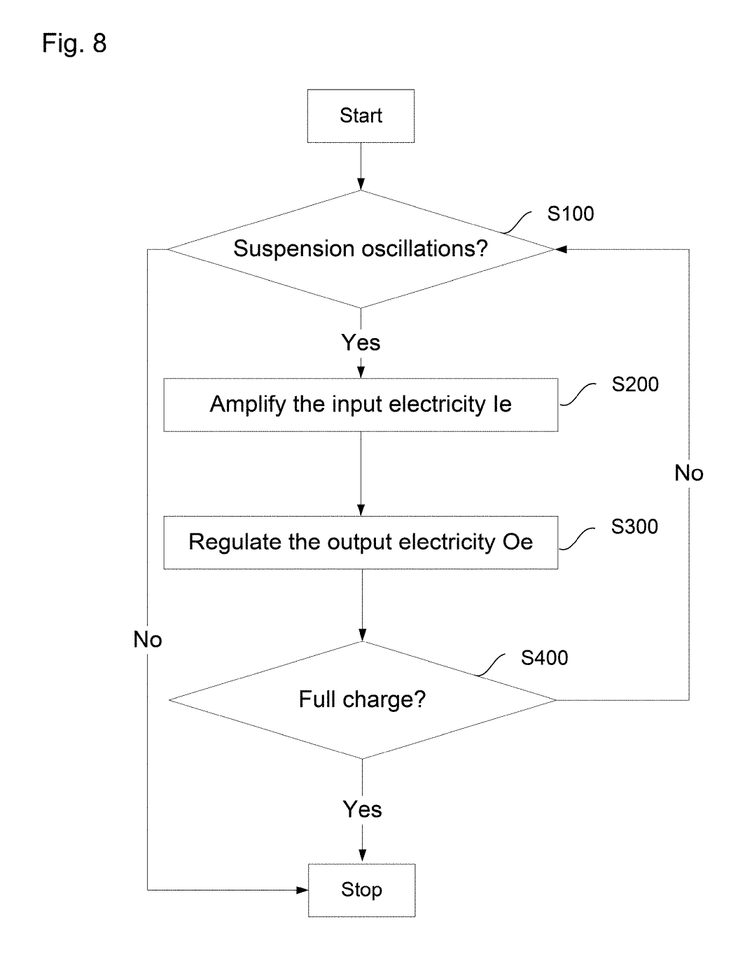

FIG. 8 is a flow chart of a method for harvesting energy through the energy recovery system 1000, according to certain aspects of the disclosure.

In a step S100, it is detected if the suspension oscillations are generated by the suspension assembly B-1000. The suspension oscillations can be detected with a voltage value of the input electricity Ie that is measured via the input voltmeter C-1310, see FIG. 7, and through software instructions executed by the electrical control unit D-1000. For example, the suspension oscillations of the suspension assembly B-1000 can be detected if the voltage value of the input electricity Ie is above a predetermined input threshold. The predetermined input threshold can correspond to amplitudes of the suspension oscillations sufficiently large to be harvested by the energy recovery system 1000.

If the suspension oscillations are detected, the process goes to a step S200. Otherwise, the process stops.

In the step S200, the input electricity Ie is amplified to provide the amplified input electricity AIe via the amplifier C-1300 and through software instructions executed by the electrical control unit D-1000. For example, the electrical control unit D-1000 can actuate the amplifier C-1300 to receive electrical power from the battery C-1100 and amplify the input electricity Ie above an excitement threshold. The excitement threshold can correspond to a minimum voltage value at which the plurality of electroactive modules A-2200 can be excited and generate the output electricity Oe when the tire assembly A-2000 undergoes the tire deformations.

In a step S300, the output electricity Oe is regulated to provide the regulated output electricity ROe via the charge regulator C-1200 and through software instructions executed by the electrical control unit D-1000. For example, the electrical control unit D-1000 can actuate the charge regulator C-1200 to reduce, e.g. through heat dissipation, the output electricity Oe when voltage values of the output electricity Oe are above a predetermined maximum battery threshold. The predetermined maximum battery threshold can correspond to voltage values for which the battery C-1100 can be damaged.

In a step S400, It is detected if the battery C-1100 is fully charged. The full charge of the battery C-1100 can be determined with a voltage value of the battery C-1100 that is measured via the battery voltmeter C-1110, see FIG. 7, and through software instructions executed by the electrical control unit D-1000. For example, the full charge of the battery C-1100 can be detected if the voltage value of the battery C-1100 is above a maximum voltage charge of the battery C-1100.

If the full charge of the battery C-1100 is detected, the process stops. Otherwise, the process goes back to the step S100.

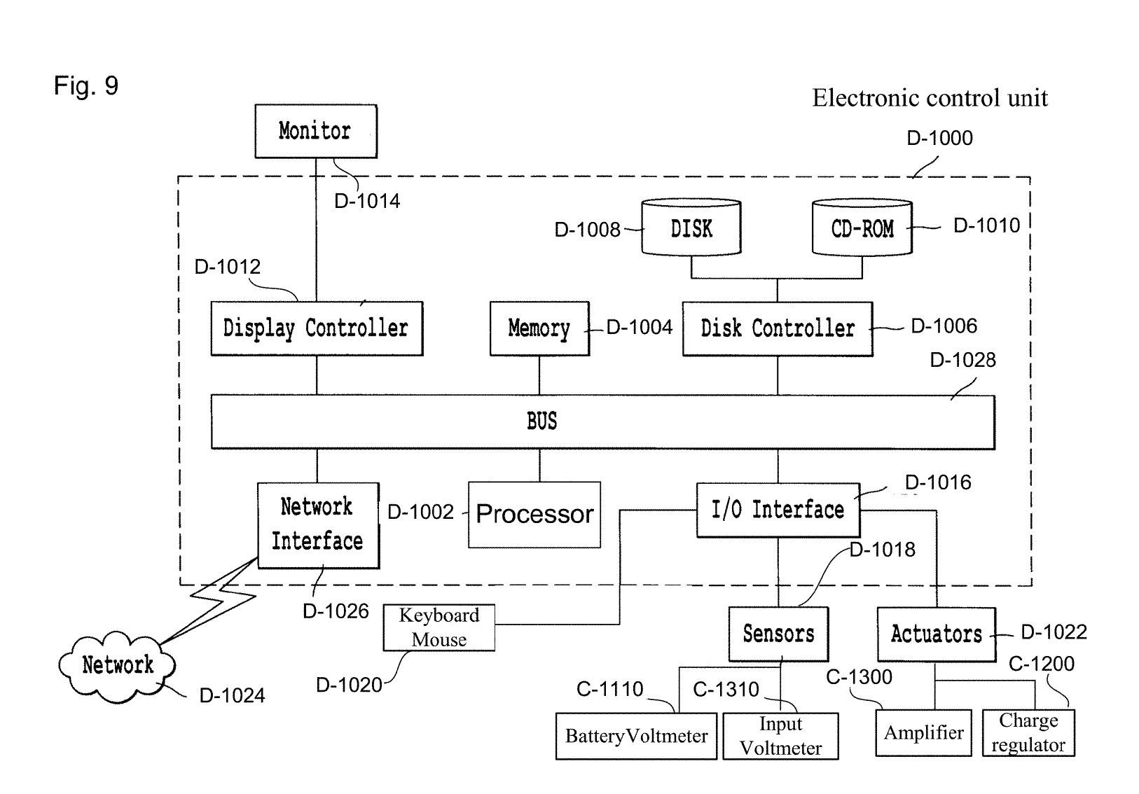

FIG. 9 is a schematic view of a hardware diagram of the electrical control unit D-1000 of the battery assembly C-1000, according to certain aspects of the disclosure.

As shown in FIG. 9, systems, operations, and processes in accordance with this disclosure may be implemented using a processor D-1002 or at least one application specific processor (ASP). The processor D-1002 may utilize a computer readable storage medium, such as a memory D-1004 (e.g., ROM, EPROM, EEPROM, flash memory, static memory, DRAM, SDRAM, and their equivalents), configured to control the processor D-1002 to perform and/or control the systems, operations, and processes of this disclosure. Other storage mediums may be controlled via a disk controller D-1006, which may control a hard disk drive D-1008 or optical disk drive D-1010.

The processor D-1002 or aspects thereof, in an alternate embodiment, can include or exclusively include a logic device for augmenting or fully implementing this disclosure. Such a logic device includes, but is not limited to, an application-specific integrated circuit (ASIC), a field programmable gate array (FPGA), a generic-array of logic (GAL), and their equivalents. The processor D-1002 may be a separate device or a single processing mechanism. Further, this disclosure may benefit form parallel processing capabilities of a multi-cored processor.

In another aspect, results of processing in accordance with this disclosure may be displayed via a display controller D-1012 to a monitor D-1014 that may be peripheral to or part of the electrical control unit D-1000. Moreover, the monitor D-1014 may be provided with a touch-sensitive interface to a command/instruction interface. The display controller D-1012 may also include at least one graphic processing unit for improved computational efficiency. Additionally, the electrical control unit D-1000 may include an I/O (input/output) interface D-1016, provided for inputting sensor data from sensors D-1018 and for outputting orders to actuators D-1022. The sensors D-1018 and actuators D-1022 are illustrative of any of the sensors and actuators described in this disclosure. For example, the sensors D-1018 can be the battery voltmeter C-1110 and the input voltmeter C-1310, while the actuators D-1022 can be the amplifier C-1300 and the charge regulator C-1200.

Further, other input devices may be connected to an I/O interface D-1016 as peripherals or as part of the electrical control unit D-1000. For example, a keyboard or a pointing device such as a mouse D-1020 may control parameters of the various processes and algorithms of this disclosure, and may be connected to the I/O interface D-1016 to provide additional functionality and configuration options, or to control display characteristics. Actuators D-1022 which may be embodied in any of the elements of the apparatuses described in this disclosure may also be connected to the I/O interface D-1016.

The above-noted hardware components may be coupled to the network D-1024, such as the Internet or a local intranet, via a network interface D-1026 for the transmission or reception of data, including controllable parameters to a mobile device. A central BUS D-1028 may be provided to connect the above-noted hardware components together, and to provide at least one path for digital communication there between.

The foregoing discussion discloses and describes merely exemplary embodiments of an object of the present disclosure. As will be understood by those skilled in the art, an object of the present disclosure may be embodied in other specific forms without departing from the spirit or essential characteristics thereof. Accordingly, the present disclosure is intended to be illustrative, but not limiting of the scope of an object of the present disclosure as well as the claims.

Numerous modifications and variations on the present disclosure are possible in light of the above teachings. It is therefore to be understood that within the scope of the appended claims, the disclosure may be practiced otherwise than as specifically described herein.

What is claimed is:

1. An energy recovery system for a vehicle, comprising:
a suspension assembly including a linear generator that provides input electricity when the vehicle goes over road deformations;
a battery assembly that is in electrical contact with the suspension assembly, the battery assembly including:
a battery, and
an amplifier that receives the input electricity from the linear generator and provides amplified input electricity; and
a wheel assembly trotatably affixed to the suspension assembly, the wheel assembly including:
a tire assembly that contacts the road deformations, the tire assembly having:
a tire, and
a plurality of electroactive modules affixed to the tire that provides output electricity when the vehicle goes over the road deformations, and
a rim assembly that supports the tire assembly, the rim assembly having:
a rim affixed to the tire, and
a dual slip ring connector affixed to the rim that transmits, while the vehicle is in motion, the amplified input electricity from the amplifier to the plurality of electroactive modules and the output electricity from the plurality of electroactive modules to the battery.

2. The energy recovery system of claim 1, wherein the plurality of electroactive modules is affixed to an internal surface of the tire.

3. The energy recovery system of claim 2, wherein the tire assembly further includes a fabric that covers the plurality of electroactive modules.

4. The energy recovery system of claim 2, wherein each electroactive module of the plurality of electroactive modules include a multi-layer polymer.

5. The energy recovery system of claim 1, wherein a dual slip ring connector includes a first slip ring connector that transmits the output electricity from the plurality of electroactive modules to the battery and a second slip ring that transmits the amplified electricity from the amplifier to the plurality of electroactive modules.

6. The energy recovery system of claim 5, wherein the first slip ring connector and the second slip ring connector include a rotating part that rotates with the rim and a stationary part that remains stationary with respect to the rim and in contact with the rotating part by slipping on the stationary part.

7. The energy recovery system of claim 6, wherein the the first slip ring connector and the second slip ring connector include a pair of brushes that slips on the stationary part.

8. The energy recovery system of claim 1, wherein the linear generator includes permanent magnets that slide along coils as the linear generator undergoes suspension oscillations to generate the input electricity.

9. The energy recovery system of claim 8, wherein the linear generator includes hydraulic fluids that dampen the suspension oscillations.

10. An energy recovery system for a vehicle, comprising:
a battery assembly, the battery assembly including:
a battery that provides input electricity, and
an amplifier that receives the input electricity and provides amplified input electricity; and
a wheel assembly that is electrically connected to the battery assembly, the wheel assembly including:
a tire assembly that contacts road deformations, the tire assembly having:
a tire, and
a plurality of electroactive modules affixed to the tire that provides output electricity when the vehicle goes over the road deformations, and
a rim assembly that supports the tire assembly, the rim assembly having:
a rim affixed to the tire, and
a dual slip ring connector affixed to the rim that transmits, while the vehicle is in motion, the amplified input electricity from the amplifier to the plurality of electroactive modules and the output electricity from the plurality of electroactive modules to the battery.

11. The energy recovery system of claim 10, wherein the plurality of electroactive modules is affixed to an internal surface of the tire.

12. The energy recovery system of claim 11, wherein the tire assembly further includes a fabric that covers the plurality of electroactive modules.

13. The energy recovery system of claim 12, wherein each electroactive modules of the plurality of electroactive modules include a multi-layer polymer.

14. The energy recovery system of claim 10, wherein a dual slip ring connector includes a first slip ring connector that transmits the output electricity from the plurality of electroactive modules to the battery and a second slip ring that transmits the amplified electricity from the amplifier to the plurality of electroactive modules.

15. The energy recovery system of claim 14, wherein the first slip ring connector and the second slip ring connector include a rotating part that rotates with the rim and a stationary part that remains stationary with respect to the rim and in contact with the rotating part by slipping on the stationary part.

16. The energy recovery system of claim 15, wherein the first slip ring connector and the second slip ring connector include a pair of brushes that slips on the stationary part.

17. An energy recovery system for a vehicle, comprising:
a battery assembly including:
a battery that provides input electricity, and
an amplifier that receives the input electricity and provides amplified input electricity; and
a wheel assembly that is electrically connected to the battery assembly, the wheel assembly including:
a tire assembly that contacts road deformations, the tire assembly having:
a tire, and
a plurality of electroactive modules affixed to the tire that provides output electricity when the vehicle goes over the road deformations, and
a rim assembly that supports the tire assembly, wherein
the rim assembly transmits, while the vehicle is in motion, the amplified input electricity from the amplifier to the plurality of electroactive modules and the output electricity from the plurality of electroactive modules to the battery.

18. The energy recovery system of claim 17, wherein the plurality of electroactive modules is affixed to an internal surface of the tire.

19. The energy recovery system of claim 18, wherein the tire assembly further includes a fabric that covers the plurality of electroactive modules.

20. The energy recovery system of claim 18, wherein each electroactive modules of the plurality of electroactive modules include a multi-layer polymer.
